(19) United States
(12) Patent Application Publication
(10) Pub. No.: US 2003/0189415 A1
(43) Pub. Date: Oct. 9, 2003

(54) Method and apparatus for pulse variable-controlled movable obstacle detection

(75) Inventor: James Fitzgibbon, Batavia, IL (US)

Correspondence Address: FITCH EVEN TABIN AND FLANNERY, 120 SOUTH LA SALLE STREET, SUITE 1600, CHICAGO, IL, 60603-3406, US

(73) Assignee: The Chamberlain Group, Inc.

(21) Appl. No.: 10/118,523

(22) Filed: Apr. 8, 2002

(51) Int. Cl. H02P 1/04

(52) U.S. Cl. 318/466

(57) ABSTRACT

Pulse variable information is used to control at least obstacle detection and also, optionally, speed of movement of a movable barrier. In one embodiment, pursuant to a learning mode the movable barrier is moved and, while moving the movable barrier, at least one pulse variable that corresponds to movement of the movable barrier at a desired speed is measured and used to determine at least one predetermined threshold that corresponds to a level of excessive force as exerted by the movable barrier. This threshold can then be used during an operating mode to facilitate detection of barrier obstacles.

### TECHNICAL FIELD

This invention relates generally to movable barrier operators and more particularly to obstacle detection with or without speed detection.

### BACKGROUND

Movable barrier operators that serve to control movement of movable barriers (including but not limited to garage doors of all types, gates, shutters, and so forth) are well known and understood in the art. Many such operators typically serve to move a movable barrier at a controlled speed and/or at controlled speeds during various segments of barrier travel (particularly when using a direct current (DC) motor to effect movement of the movable barrier). In addition, or in the alternative, many such operators serve to detect in various ways whether an obstacle is presently in the path of travel of the movable barrier. Upon detecting such an obstacle, various actions can be taken to better ensure safety for the obstacle and the movable barrier.

As shown in phantom lines in FIG. 1, DC motors can exhibit a relatively linear relationship between speed and resultant force, provided the DC motor is driven with a relatively constant and stable DC voltage. Under such circumstances, for example, a first linear relationship 11 occurs at a first applied DC voltage and a second linear relationship 12 occurs at a second (in this case, lower) applied DC voltage. Such linear behavior would have beneficial application when seeking to control speed of a DC motor driven movable barrier and/or to ascertain force as presently being exhibited by a given movable barrier. Unfortunately, controlling a DC motor with a linearly variable DC voltage is not the norm. For a variety of worthy reasons, movable barrier operators that use DC motors tend not to utilize such a control strategy.

Instead, many DC motor-based movable barrier operators use pulse variable control signals to dictate control of the corresponding DC motor. Pulse width modulation techniques are particularly common, but other pulse variable mechanisms are suitable as well, including, for example, pulse density modulation, pulse amplitude modulation, and combinations thereof. While pulse variable techniques are generally effective to meet the control requirements of a movable barrier operator, use of such techniques does present certain counterpart challenges. For example, the force/speed relationship typically becomes non-linear over at least a portion of the dynamic operating range of the motor. For example, as shown in FIG. 1 by solid lines, the resultant force/speed relationship 13 at one given pulse variable setting can be seen to be at least partially non-linear as is the resultant force/speed relationship 14 at a reduced pulse variable setting. (Note: the curves depicted are not exact nor necessarily proportionally accurate—they are intended only to generically illustrate the general nature of the relationships and properties described.)

This non-linear behavior complicates certain kinds of desired control needs. For example, maintaining a desired speed or sequence of speeds and/or reliably detecting an obstacle through applied force detection are both rendered more complicated due to such phenomena. One prior art approach seeks to ameliorate this challenge by use of a current sensing transformer. By directly sensing current flow to the DC motor, a reasonable estimate of torque (and hence, force) can be determined, which information can be used accordingly. Unfortunately, this approach necessitates increased hardware content, complexity, and cost.

### BRIEF DESCRIPTION OF THE DRAWINGS

The above needs are at least partially met through provision of the method and apparatus for pulse variable controlled movable barrier obstacle detection described in the following detailed description, particularly when studied in conjunction with the drawings, wherein:

FIG. 1 comprises a depiction of force/speed relationships for prior art DC motors;

FIG. 2 comprises a block diagram depiction of relevant portions of a movable barrier operator as configured in accordance with an embodiment of the invention;

FIG. 3 comprises a graph depicting 30% pulse width modulation control signals as configured in accordance with an embodiment of the invention;

FIG. 4 comprises a graph depicting 70% pulse width modulation control signals as configured in accordance with an embodiment of the invention;

FIG. 5 comprises a flow diagram depicting a learning mode as configured in accordance with an embodiment of the invention;

FIG. 6 comprises a flow diagram depicting an operational mode as configured in accordance with an embodiment of the invention;

FIG. 7 comprises a flow diagram depicting an optional operational mode as configured in accordance with an embodiment of the invention; and

FIG. 8 comprises a flow diagram depicting another optional operational mode as configured in accordance with an embodiment of the invention.

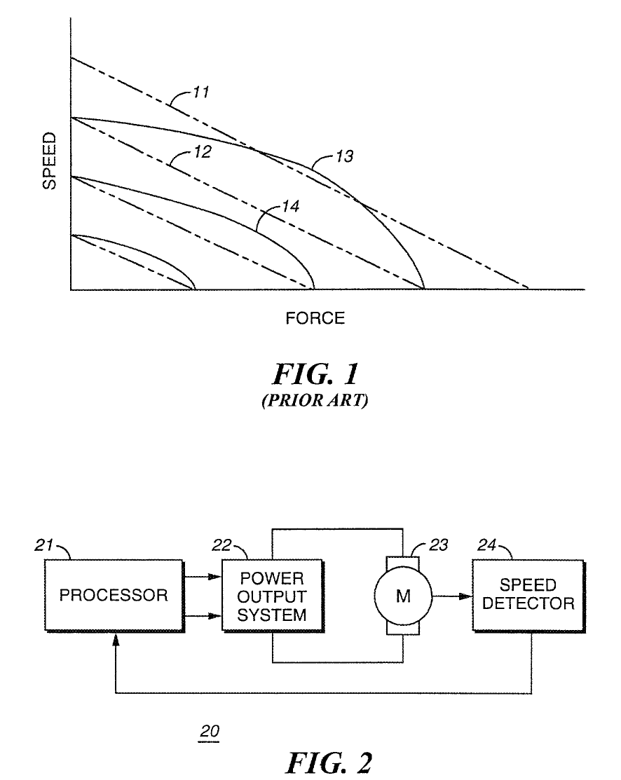

Skilled artisans will appreciate that elements in the figures are illustrated for simplicity and clarity and have not necessarily been drawn to scale. For example, the dimensions of some of the elements in the figures may be exaggerated relative to other elements to help to improve understanding of various embodiments of the present invention. Also, common but well-understood elements that are useful or necessary in a commercially feasible embodiment are typically not depicted in order to facilitate a less obstructed view of these various embodiments of the present invention.

### DETAILED DESCRIPTION OF A PREFERRED EMBODIMENT

Generally speaking, these various embodiments provide a movable barrier operator having a motor operably coupled to a movable barrier, a speed detector having an input operably coupled to the motor and an output, a pulse modulated speed controller having a pulse controlled input and a motive output operably coupled to the motor, and a processing platform having an input operably coupled to the output of the speed detector and at least one output operably coupled to the pulse controlled input of the pulse modulated speed controller. The processing platform can include a program or other effective series of instructions and/or functionality that can effect a learning mode and/or an operational mode as described below.

During an optional learning mode, the processing platform causes and/or monitors movement of the movable barrier and measures at least one pulse variable that corresponds to movement of the movable barrier at a desired speed. Depending upon the embodiment and application, only one such measurement may be taken during the learning mode or a plurality of such measurements can be taken during travel of the movable barrier from a starting position (such as a fully open or fully closed position) to a concluding position (such as a fully closed or fully open position). To the extent that multiple measurements are taken, they can either be combined in some desired way (such as, for example, by determining an average or a peak value) to yield fewer (or one) resultant measurement or they can be used in correlation to specific locations of the movable barrier (such that specific positions of the movable barrier have a corresponding pulse variable measurement). The results are then stored as is, or processed further as appropriate for a given embodiment to render such data suitable for later use (such as, for example, by manually modifying one or more items of data to reflect local operational circumstances or needs of a given installer or other user).

During the operational mode, speed of the DC motor can be determined and compared with a present desired speed. That comparison is used to determine whether the speed controlling pulse variable should be modified. The resultant pulse variable (as increased, decreased, or left as-is) is then used to control a subsequent speed of the movable barrier.

In one embodiment, the resultant pulse variable can also be compared against a value that represents a maximum force that may be applied (a condition requiring application of force in excess of such a value is presumed to indicate the presence of an obstacle). In this way, force information, and hence obstacle information, is inferred and detected without need for motor current measurement or other external measurements.

These various embodiments can be realized with substantially minimized hardware component count and complexity and with good efficacy and accuracy. These embodiments are compatible with various control strategies including both simple control systems (which effect only one desired speed and/or one maximum force threshold over the entire travel distance of the movable barrier) and more complicated control systems (which effect various speeds and/or utilize various maximum force thresholds as correspond to various positions of the movable barrier during its travel). And, in addition to being accurate, efficient, and readily flexible and compliant with a variety of control strategies, these embodiments are also relatively cost effective.

Referring now to FIG. 2, pertinent elements of a movable barrier operator 20 are shown. The movable barrier operator 20 includes a processor 21 (which can be, as well understood in the art, a microprocessor or microcontroller in a relatively simple application or a more complex multi-part platform as appropriate) that provides, in this embodiment, pulse modulated speed control signals to a power output system 22 that in turn drives a DC motor 23 using such signals. The motor 23 couples through an appropriate drive mechanism to a movable barrier to effect desired movement of the movable barrier (the latter components are not shown for purposes of clarity and focus). The motor 23 also couples, in this embodiment, to a speed detector 24 (which can be, for example, a tachometer). The speed detector 24 determines (or facilitates determination of) present speed of the motor 23 and provides this information back to the processor 21.

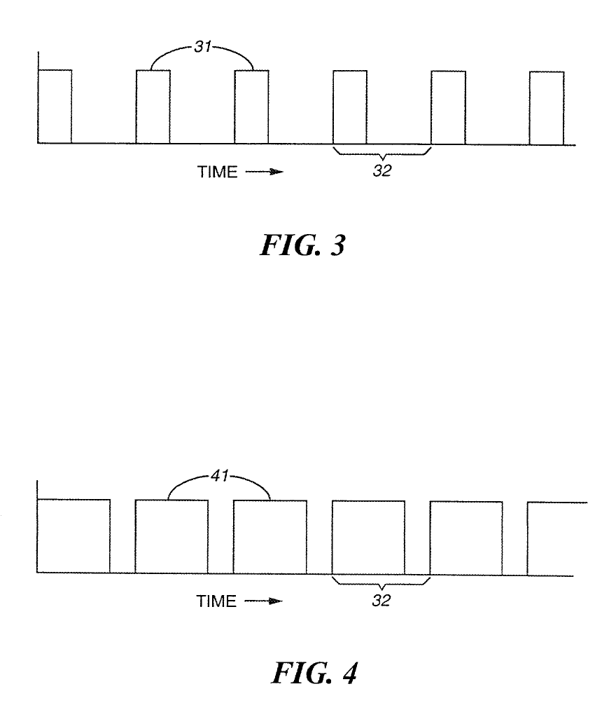

So configured, the movable barrier operator 20 comprises a programmable platform that will readily support the various operational behaviors and activities set forth herein in a manner familiar to and well understood by those skilled in the art. As noted earlier, various kinds of pulse variable control schemes are relevant to and compatible with the embodiments taught herein. For purposes of describing these embodiments, however, a specific example will be used as a non-limiting point of reference. In particular, pulse width modulation will be used as an exemplar controlling mechanism. For example, with reference to FIG. 3, a 30% pulse width modulation can be achieved by provided periodic pulses 31 that each constitute 30% of the available time for the pulse window 32. Similarly, a 70% pulse width modulation can be achieved as shown in FIG. 4 by providing periodic pulses 41 that each constitute 70% of the pulse window 32. Such pulses can be used in various known ways to control a resultant drive voltage (or current or other motive vehicle) for, in these embodiments, a DC motor 23 such that the speed of the motor 23 is substantially controlled thereby.

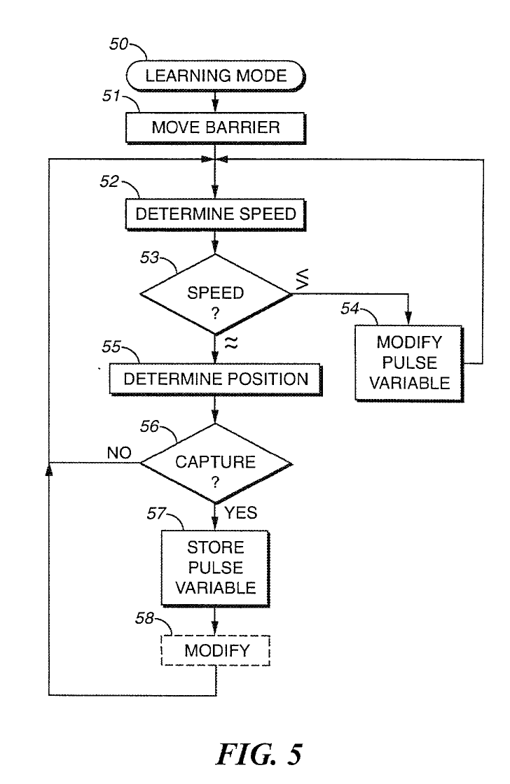

For some embodiments, it is helpful or appropriate to initially automatically (or partially automatically) develop certain information regarding pulse width variables as used to effect the desired pulse width modulation. With reference now to FIG. 5, such information can be developed pursuant to an optional learning mode 50 of operation (which learning mode 50 can be effected by the processor 21 or by such other implementation platform as may be desired in a given application). The processor 21 moves 51 the movable barrier (for example, from a known fully open position to a closed position) and determines 52 the present speed of barrier movement (the speed detector 24 can be used to provide such information in these embodiments). That present speed is then compared 53 against a desired speed. The desired speed is typically a pre-established value that can be retrieved from memory. The desired speed may be constant for the entire length of travel or it may vary with position of the movable barrier (for example, the movable barrier may move the last few inches into a closed position at a slower speed than is used to move the movable barrier the majority of its travel). When this comparison 53 indicates that the present speed is either less than or greater than the desired speed (either in absolute terms or beyond a tolerance threshold or setting as desired) the processor modifies 54 the pulse variable. The modified pulse value is then used to control subsequent speed of the movable barrier and the process continues.

When the present speed and desired speed are within an acceptable range of one another, the processor 21 in this embodiment also determines 55 from time to time the present movable barrier position. There are various known ways to so determine movable barrier position and location and for purposes of brevity and clarity no further description of such alternatives will be made here. The processor 21 then determines 56 whether the movable barrier position equates with a predetermined position, and if so, the processor 21 captures the present pulse variable information and stores 57 it for subsequent use as described below. If desired, the learning process can also optionally accommodate a manual or automatic modification 58 of the stored pulse variable (for example, this value can be automatically offset by a given value and/or manually modified (within a given limited range or without any particular limit as suits a particular context) by an individual such as an installer).

In this way, information regarding one or more pulse variables as correspond to travel of the movable barrier at various positions can be ascertained (fully or partially automatically) and stored for later reference and usage.

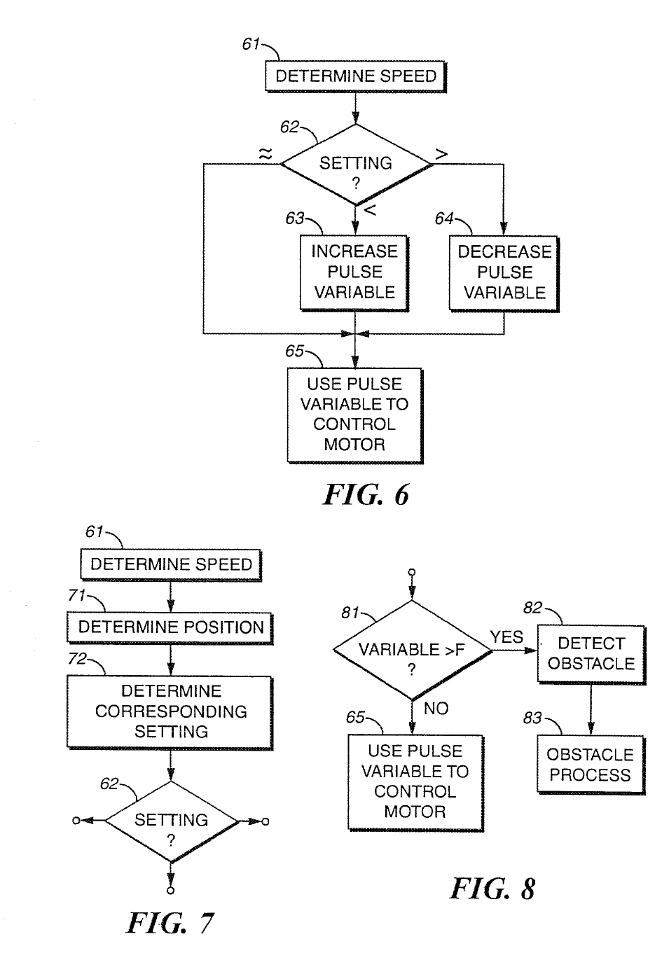

Various embodiments of the movable barrier operator 20 will also support various operational modes. For example, and referring now to FIG. 6, the processor 21 can, during normal operation of the movable barrier, determine 61 present speed of the movable barrier (again through use of the speed detector 24) and then compare 62 this present speed with a present desired speed. When the present speed and desired speed equate within an acceptable range of similarity, the processor 21 can simply continue to use 65 the present pulse variable without change to control the speed of the motor 23. When the present speed and desired speed are sufficiently divergent, however, the processor 21 can increase 63 the pulse variable or decrease 64 the pulse variable as appropriate and then use the resultant pulse variable for subsequent control of the motor 23. The amount by which the pulse variable is increased or decreased can be varied as appropriate to a given application. The variance can be effected by incrementing or decrementing the pulse variable by a constant set value, or by a varying value (wherein the variance can be determined dynamically in a variety of ways as appropriate to a given circumstance and application).

As noted earlier, it is possible, in a given system, to have a plurality of desired speeds as correspond to various positions of the movable barrier. When using such a position-slaved speed control scheme, the above-described process can be modified accordingly. For example, with reference to FIG. 7, a present position of the movable barrier can be determined 71 (through any of a variety of known mechanisms) and that position information then used to determine 72 (through, for example, calculation or by use of a previously developed and stored look-up table) a corresponding desired speed for that location. The process can then continue as described above by using this particular desired speed value for comparison purposes.

As noted earlier, in addition to controlling speed in a cost effective and efficient manner, the pulse variable information can also be used to aid in detecting an obstacle in the path of the moving barrier. With reference to FIG. 8, once the pulse variable has been incremented or decremented as described above with respect to FIG. 6, that resultant pulse variable can be compared 81 with a force threshold as recovered from memory that represents, for example, a maximum allowed force (or excessive force) as previously set or otherwise established manually and/or automatically (as with speed, the maximum allowable force can also vary, if desired, with present location of the movable barrier - when so configured, then the appropriate force threshold value as corresponds to present location of the movable barrier should of course be first obtained and then used for this comparison 81). When the resultant pulse variable does not exceed the maximum force threshold, the process can simply continue as described above by using 65 the pulse variable to control the motor. When, however, the resultant pulse variable does exceed the maximum force threshold, this information can be used to facilitate detection 82 of an obstacle in the path of the movable barrier (which obstacle is presumably now blocking movement of the movable barrier and hence giving rise to the rising applied force via increasing applied torque). So detected, the process can then revert to whatever detected-obstacle process 83 is ordinarily used (for example, further motion of the movable barrier can be halted and/or reversed, alarms can be sounded, lights can be illuminated, and so forth). So configured, the pulse modulation information as used to control speed of movement of the movable barrier is also used effectively and efficiently to also determine when the movable barrier has likely encountered an obstacle. In addition, if desired, such information can be used for obstacle detection without concurrent speed control application.

Through these various embodiments, speed and/or force detection (and hence, obstacle detection) is accomplished without current sensing mechanisms and with a relatively small number of elements and steps. In effect, these important attributes are gained with little in the way of additional required hardware overhead.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method of controlling a movable barrier operator, comprising:
determining a present speed of the movable barrier;
when the present speed is less than a predetermined value by at least a predetermined amount, increasing a corresponding pulse variable to provide a resultant pulse variable;
when the present speed is more than the predetermined value by at least a predetermined amount, decreasing the corresponding pulse variable to provide a resultant pulse variable;
determining whether the resultant pulse variable exceeds a predetermined threshold that corresponds to an excessive force.

2. The method of claim 1 wherein determining the present speed of the movable barrier includes using a tachometer to determine the present speed of the movable barrier.

3. The method of claim 1 and further comprising:
using the resultant pulse variable to control a subsequent speed of the movable barrier.

4. The method of claim 1 and further comprising determining the predetermined threshold by accessing a previously stored value.

5. The method of claim 1 and further comprising automatically determining the predetermined threshold during a learning mode.

6. The method of claim 1 and further comprising:
automatically determining a candidate predetermined threshold during a learning mode;
manually modifying the candidate predetermined threshold to provide the predetermined threshold.

7. The method of claim 1 and further comprising, when the resultant pulse variable exceeds the predetermined threshold, at least stopping present movement of the movable barrier.

8. The method of claim 1 and further comprising, when the resultant pulse variable exceeds the predetermined threshold, reversing a direction of movement of the movable barrier.

9. A method for use with a movable barrier operator and a corresponding movable barrier, comprising:
during a learning mode:
moving the movable barrier;
while moving the movable barrier, measuring at least one pulse variable that corresponds to movement of the movable barrier at a desired speed;
using the at least one pulse variable to determine at least one predetermined threshold that corresponds to a level of excessive force as exerted by the movable barrier;
storing data that at least corresponds to the at least one predetermined threshold;
during an operational mode:
determining a present speed of the movable barrier;
when the present speed is less than a predetermined value by at least a predetermined amount, increasing a corresponding pulse variable to provide a resultant pulse variable;
when the present speed is more than the predetermined value by at least a predetermined amount, decreasing the corresponding pulse variable to provide a resultant pulse variable;
determining whether the resultant pulse variable exceeds a predetermined threshold that corresponds to an excessive force;
when the resultant pulse variable exceeds the predetermined threshold, taking a predetermined action with respect to further movement of the movable barrier in a current direction of movement of the movable barrier;
when the resultant pulse variable does not exceed the predetermined threshold, using the resultant pulse variable to control a subsequent speed of the movable barrier.

10. A movable barrier operator comprising:
a motor operably coupled to a movable barrier;
a speed detector having an input operably coupled to the motor and an output;
a pulse modulated speed controller having a pulse controlled input and a motive output operably coupled to the motor;
a processing platform having an input operably coupled to the output of the speed detector and at least one output operably coupled to the pulse controlled input of the pulse modulated speed controller, wherein the processing platform includes a program comprising instructions to:
during a learning mode:
move the movable barrier;
while moving the movable barrier, measure at least one pulse variable that corresponds to movement of the movable barrier at a desired speed;
use the at least one pulse variable to determine at least one predetermined threshold that corresponds to a level of excessive force as exerted by the movable barrier;
store data that at least corresponds to the at least one predetermined threshold;
and during an operational mode:
determine a present speed of the movable barrier;
when the present speed is less than a predetermined value by at least a predetermined amount, increase a corresponding pulse variable to provide a resultant pulse variable;
when the present speed is more than the predetermined value by at least a predetermined amount, decrease the corresponding pulse variable to provide a resultant pulse variable;
determine whether the resultant pulse variable exceeds a predetermined threshold that corresponds to an excessive force;
when the resultant pulse variable exceeds the predetermined threshold, at least stopping continued movement of the movable barrier in a current direction of movement;
when the resultant pulse variable does not exceed the predetermined threshold, using the resultant pulse variable to control a subsequent speed of the movable barrier.

11. The movable barrier operator of claim 10 wherein the processing platform further includes a program comprising instructions to use the resultant pulse variable to control a subsequent speed of the movable barrier.

12. A method comprising:
using pulse modulation information to control speed of movement of a movable barrier; and
using the pulse modulation information to determine when the movable barrier has likely encountered an obstacle.

13. The method of claim 12 wherein using the pulse modulation information to determine when the movable barrier has likely encountered an obstacle includes comparing the pulse modulation information with at least one force threshold value to determine when the movable barrier has likely encountered an obstacle.

14. The method of claim 13 and further comprising automatically determining the at least one force threshold value during a learning mode.

15. The method of claim 13 and further comprising obtaining the at least one force threshold value from memory.

16. The method of claim 13 wherein comparing the pulse modulation information with at least one force threshold value to determine when the movable barrier has likely encountered an obstacle includes comparing the pulse modulation information with at least one force threshold value that corresponds to a present location of the movable barrier to determine when the movable barrier has likely encountered an obstacle.

17. A method comprising:
determining a required pulse modulated control signal to effect movement of a movable barrier at a desired speed;
using the pulse modulation information to determine a corresponding present approximate torque value being exerted by a motor that is moving the movable barrier;
using the torque value to determine when the movable barrier has likely encountered an obstacle.
